(19) United States
(12) Patent Application Publication
(10) Pub. No.: US 2016/0105205 A1
(43) Pub. Date: Apr. 14, 2016

(54) Hinged Sleeve for a Mobile Device

(71) Applicant: DCAZE Company Limited, Ma On Shan (HK)

(72) Inventor: Chi Man Leung, Ma On Shan (HK)

(21) Appl. No.: 14/509,574

(22) Filed: Oct. 8, 2014

(51) Int. Cl. H04B 1/3888; H04W 88/02

(52) U.S. Cl. CPC H04B 1/3888; H04W 88/02

(57) ABSTRACT

A sleeve for a mobile computing device. The sleeve includes a top surface, a bottom surface, and a friction hinge disposed between the top surface and the bottom surface. The top surface includes a plurality of first edges. The bottom surface includes a plurality of second edges. One or more of the plurality of second edges are attached to one or more of the plurality of first edges to form a pocket for the mobile computing device. The friction hinge is configured to incline a portion of the top surface when in a closed position to provide an inclined surface onto which the mobile computing device may be disposed. The friction hinge is configured to maintain its position when a mobile computing device is placed on the top surface.

### FIELD OF THE INVENTION

The present invention relates to a popup sleeve with a hinge, the popup sleeve configured as a sleeve for a mobile computing device.

### BACKGROUND OF THE INVENTION

Mobile computing devices are carried by their users and are thereby subject to physical impacts, spills, or other damage. Numerous cases and sleeves exist for protecting mobile computing devices against such damage.

### SUMMARY OF THE INVENTION

In accordance with an aspect of the present invention, there is provided a sleeve for a mobile computing device. The sleeve includes a top surface, a bottom surface, and a friction hinge disposed between the top surface and the bottom surface. The top surface includes a plurality of first edges. The bottom surface includes a plurality of second edges. One or more of the plurality of second edges are attached to one or more of the plurality of first edges to form a pocket for the mobile computing device. The friction hinge is configured to incline a portion of the top surface when in a closed position to provide an inclined surface onto which the mobile computing device may be disposed. The friction hinge is also configured to maintain its position when a mobile computing device is placed on the top surface.

### BRIEF DESCRIPTION OF THE DRAWINGS

For the purpose of illustration, there are shown in the drawings certain embodiments of the present invention. In the drawings, like numerals indicate like elements throughout. It should be understood that the invention is not limited to the precise arrangements, dimensions, and instruments shown. In the drawings:

FIG. 1 illustrates a top plan view of an exemplary embodiment of a mobile device popup sleeve in a folded position, in accordance with an exemplary embodiment of the present invention;

FIG. 2 illustrates a bottom plan view of the mobile device popup sleeve of FIG. 1, in accordance with an exemplary embodiment of the present invention;

FIG. 3 illustrates a right side elevational view of the mobile device popup sleeve of FIG. 1, in accordance with an exemplary embodiment of the present invention;

FIG. 4 illustrates a left side elevational view of the mobile device popup sleeve of FIG. 1, in accordance with an exemplary embodiment of the present invention;

FIG. 5 illustrates a front elevational view of the mobile device popup sleeve of FIG. 1, in accordance with an exemplary embodiment of the present invention;

FIG. 6 illustrates a rear elevational view of the mobile device popup sleeve of FIG. 1, in accordance with an exemplary embodiment of the present invention;

FIG. 7 illustrates a rear perspective view of the mobile device popup sleeve of FIG. 1, in accordance with an exemplary embodiment of the present invention;

FIG. 8 illustrates a front perspective view of the mobile device popup sleeve of FIG. 1, in accordance with an exemplary embodiment of the present invention;

FIG. 9 illustrates a rear perspective view of the mobile device popup sleeve of FIG. 1 shown in an alternate unfolded position, wherein an opening of the mobile device popup sleeve is shown opened, in accordance with an exemplary embodiment of the present invention;

FIG. 10 illustrates a top plan view of the mobile device popup sleeve of FIG. 1 shown in the alternate unfolded position, in accordance with an exemplary embodiment of the present invention;

FIG. 11 illustrates a bottom plan view of the mobile device popup sleeve of FIG. 1 shown in the alternate unfolded position, in accordance with an exemplary embodiment of the present invention;

FIG. 12 illustrates a right side elevational view of the mobile device popup sleeve of FIG. 1 shown in the alternate unfolded position, in accordance with an exemplary embodiment of the present invention;

FIG. 13 illustrates a top plan view of the mobile device popup sleeve of FIG. 1 including a cutaway view of an internal friction hinge, in accordance with an exemplary embodiment of the present invention

FIG. 14 illustrates a perspective view of the mobile device popup sleeve of FIG. 1 with a tablet computer disposed thereon in a first position, in accordance with an exemplary embodiment of the present invention; and

FIG. 15 illustrates another perspective view of the mobile device popup sleeve of FIG. 1 with the tablet computer of FIG. 14 disposed thereon in a second position, in accordance with an exemplary embodiment of the present invention.

### DETAILED DESCRIPTION OF THE INVENTION

Reference to the drawings illustrating various views of exemplary embodiments of the present invention is now made. In the drawings and the description of the drawings herein, certain terminology is used for convenience only and is not to be taken as limiting the embodiments of the present invention. Furthermore, in the drawings and the description below, like numerals indicate like elements throughout.

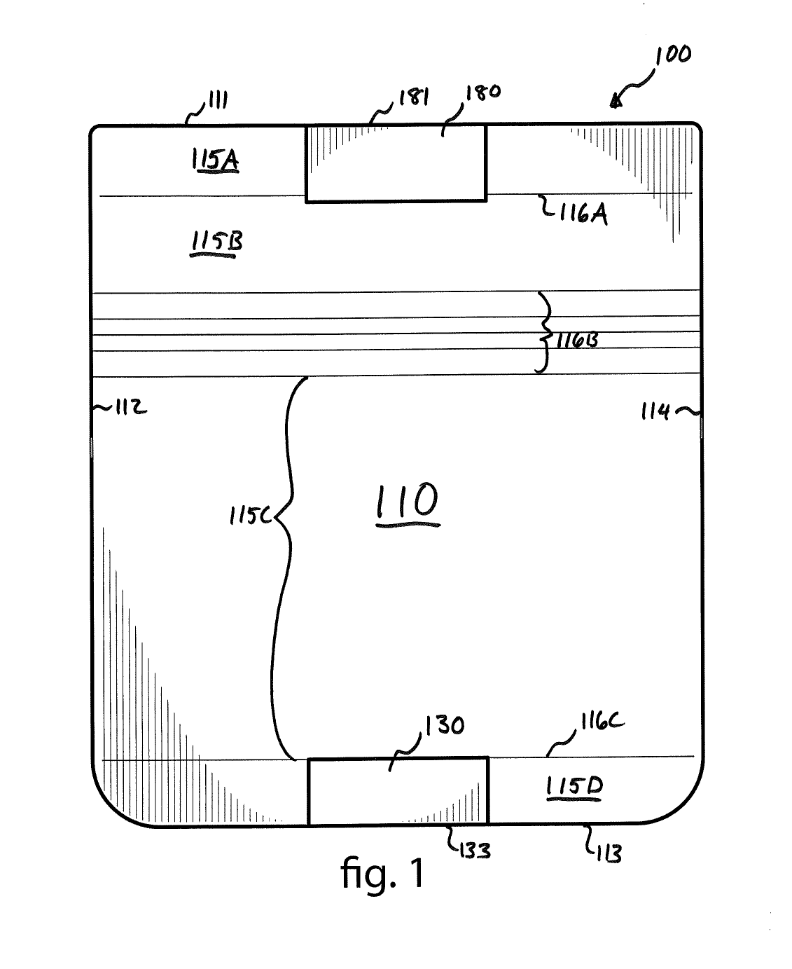

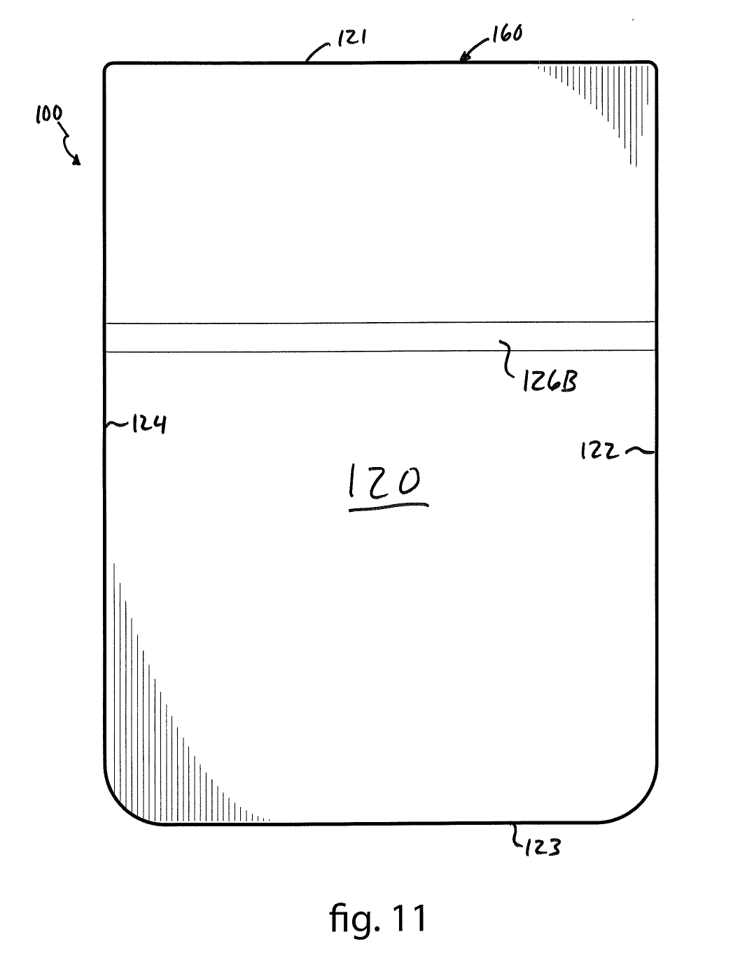

Illustrated in FIGS. 1-13 is a mobile device popup sleeve 10, in accordance with an exemplary embodiment of the present invention. The mobile device popup sleeve 100 serves as both a protective sleeve for a mobile computing device and a stand onto which the mobile computing device may be placed when a user is using it. The mobile computing device may be any mobile computing device, such as a tablet computer, mobile phone, smart phone, etc.

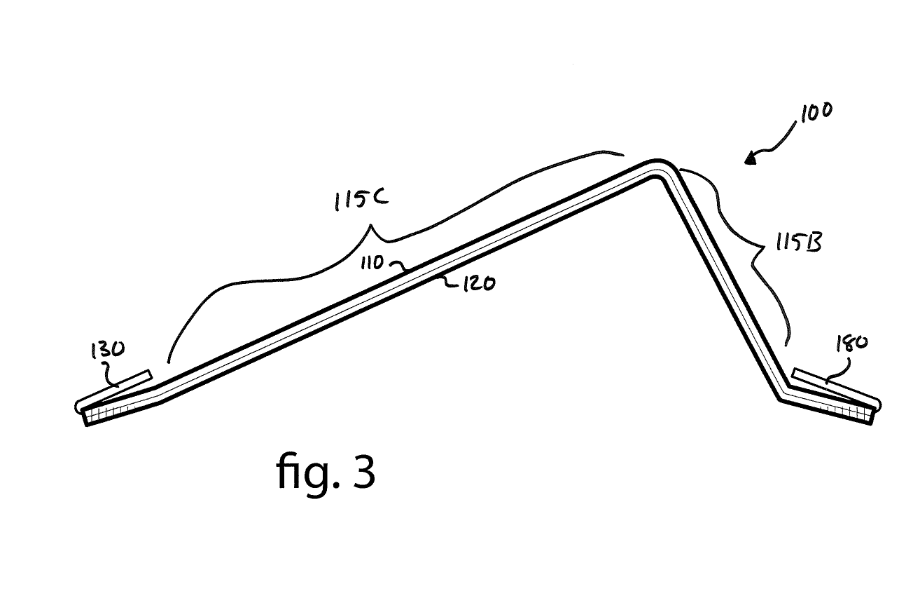

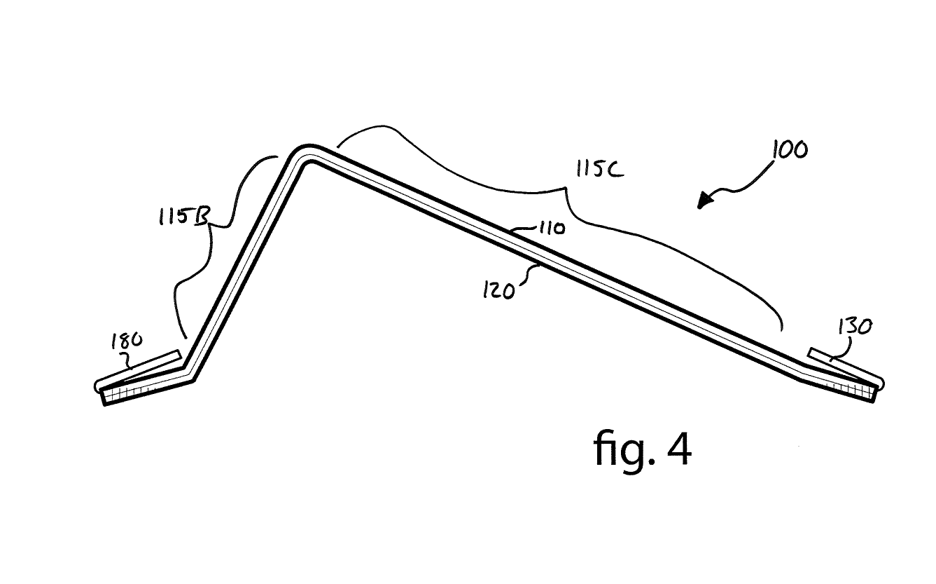

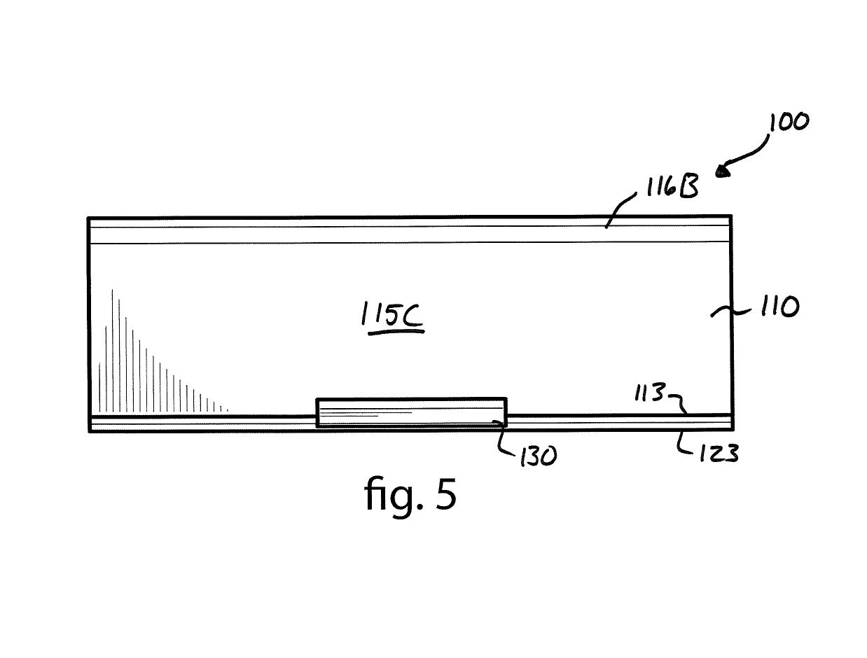

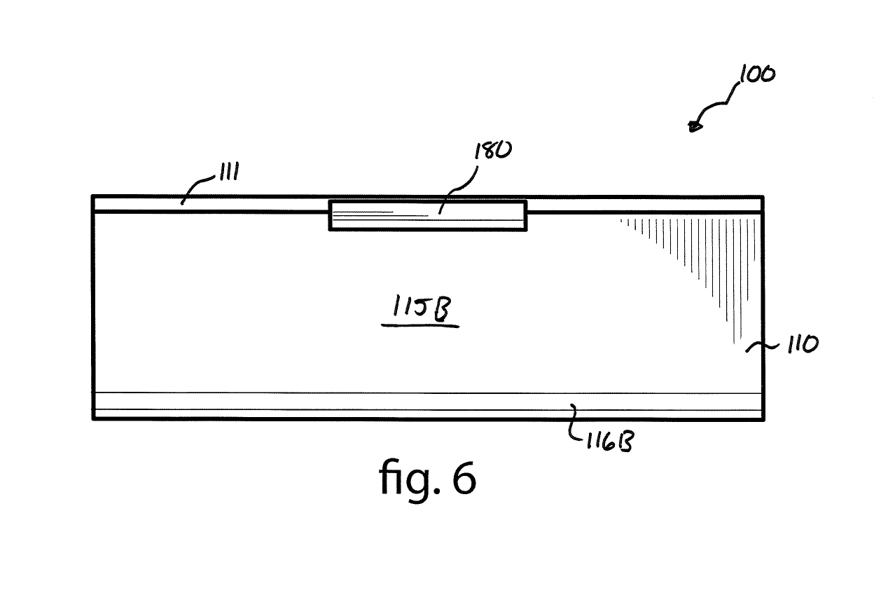

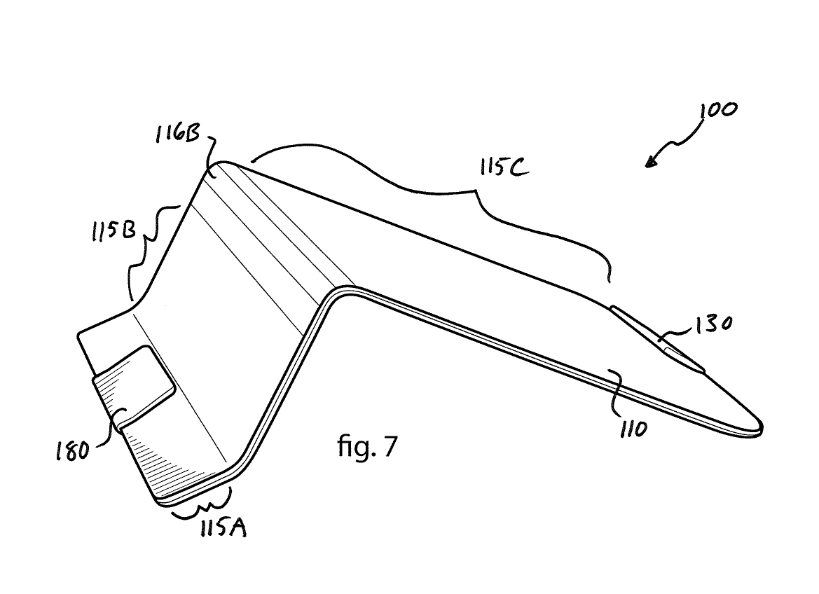

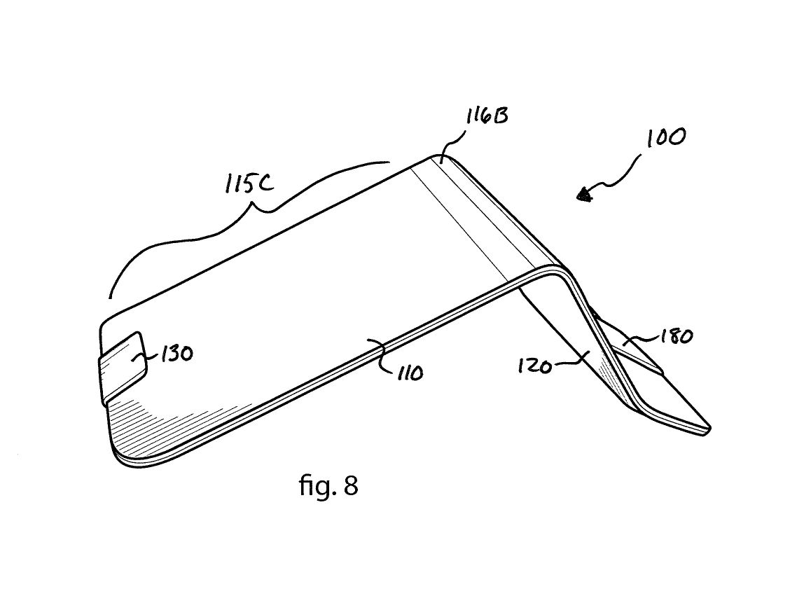

FIG. 1 illustrates a top plan view of the mobile device popup sleeve 100. FIG. 3 illustrates a right side elevational view of the mobile device popup sleeve 100, and FIG. 4 illustrates a left side elevational view of the mobile device popup sleeve 100. FIG. 5 illustrates a front elevational view of the mobile device popup sleeve 100; FIG. 6 illustrates a rear side elevational view of the mobile device popup sleeve 100; FIG. 7 illustrates a rear perspective view of the mobile device popup sleeve 100; and FIG. 8 illustrates a front perspective view of the mobile device popup sleeve 100.

Referring to FIGS. 1 and 3-8 together, the mobile device popup sleeve 100 comprises a top surface 110 comprising a rear edge 111, a front edge 113, a left side edge 112, and a right side edge 114. The mobile device popup sleeve 100 further comprises a front tab 130 comprising a front edge 133 and a rear tab 180 comprising a rear edge 181. The front edge 133 of the tab 130 is secured to the front edge 113 of the top surface 110, thereby securing the tab 130 to the top surface 110 of the mobile device popup sleeve 100.

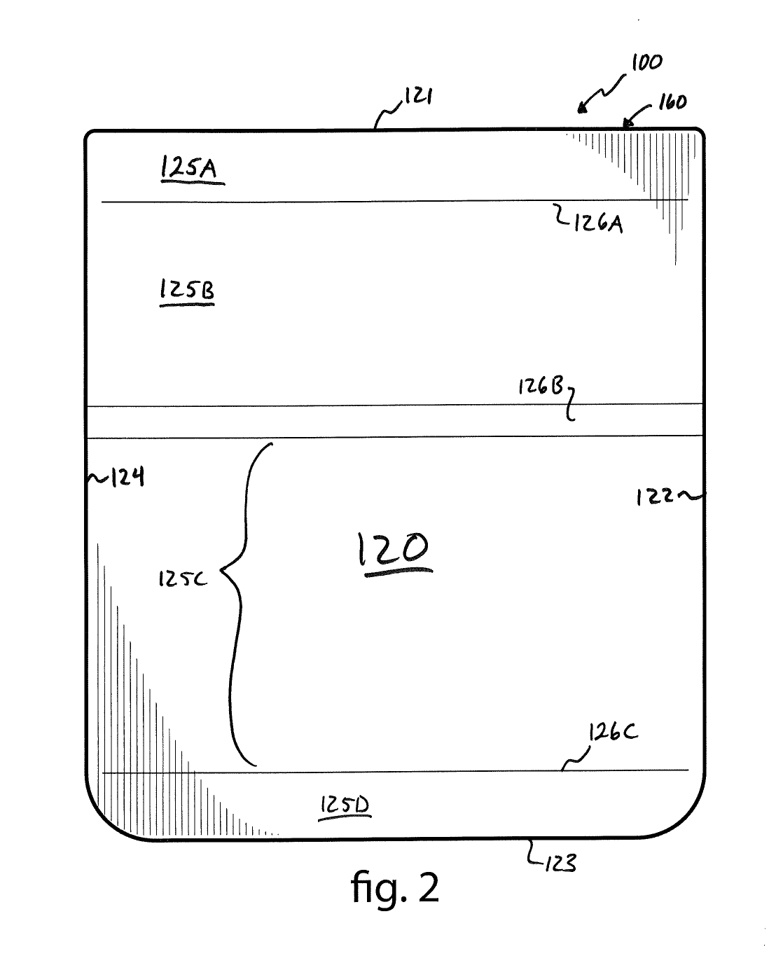

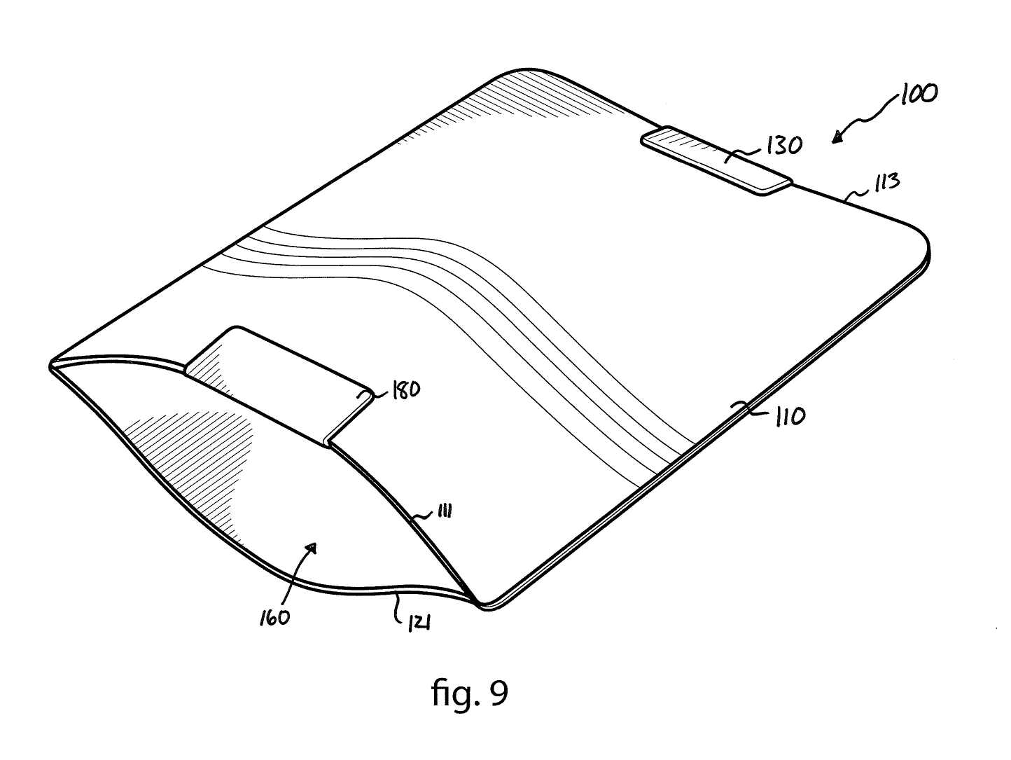

FIG. 2 illustrates a bottom plan view of the mobile device popup sleeve 100. Referring to FIG. 2, the mobile device popup sleeve 100 further comprises a bottom surface 120 comprising a rear edge 121, a front edge 123, a left side edge 124, and a right side edge 122. The front edge 123 of the bottom surface 120 is attached to the front edge 113 of the top surface 110 of the mobile device popup sleeve 100. The left edge 124 of the bottom surface 120 is attached to the right edge 114 of the top surface 110 of the mobile device popup sleeve 100. The right edge 122 of the bottom surface 120 is attached to the left edge 112 of the top surface 110 of the mobile device popup sleeve 100. The rear edge 121 of the bottom surface 120 is not attached to the rear edge 111 of the top surface 110 of the mobile device popup sleeve 100. Rather, the rear edges 111 and 121 form the sides of an opening to a pocket 160 (best seen in FIG. 9) of the mobile device popup sleeve 100.

With reference to FIGS. 1 and 2, the mobile device popup sleeve 100 further comprises a number of fold regions 116A, 116B, and 116C on the top surface 110 and a number of fold regions 126A, 126B, and 126C on the bottom surface 120 when the mobile device popup sleeve 100 is in the folded position, i.e., the skewed A shape. The fold regions 116A-C divide the top surface 110 into surface portions 115A, 115B, 115C, and 115D, and the fold regions 126A-C divide the bottom surface 120 into surface portions 125A, 125B, 125C, and 125D. The surface portions 115A and 115B provide a first resting surface for a first position of a mobile device, and the surface portions 115C and 115D provide a second resting surface for a second position of a mobile device. When in the folded position (the skewed A), the surface portions 115B and 115C are inclined.

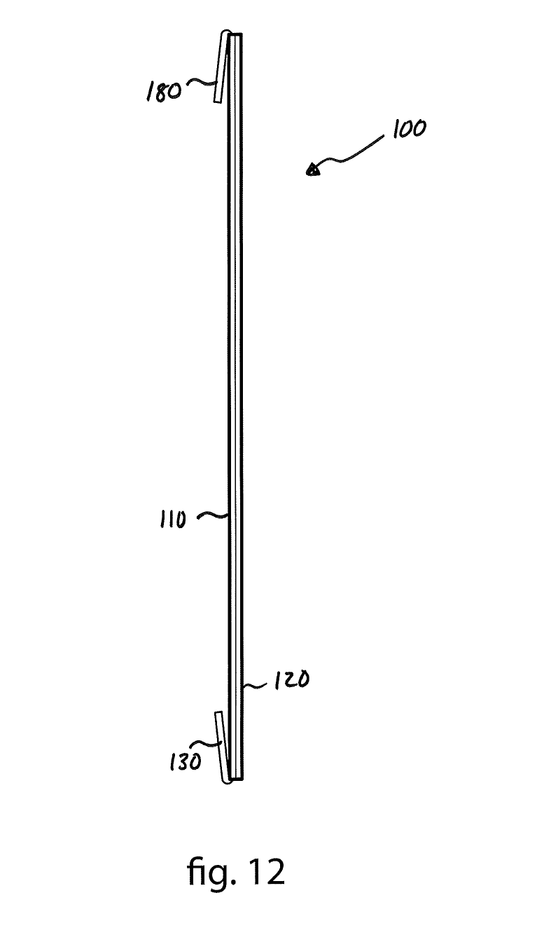

FIGS. 1-8, 14, and 15 illustrate the mobile device popup sleeve 100 in a folded position. FIGS. 9-13 illustrate the mobile device popup sleeve in an unfolded position. When in the folded position, the shape of the side profile of the body (comprising the top surface 110 and the bottom surface 120) of the mobile device popup sleeve 100 is one of a skewed “A,” as best seen in FIGS. 3 and 4. When in the unfolded position, the body (comprising the top surface 110 and the bottom surface 120) of the mobile device popup sleeve 100 is planar, as best seen in FIG. 12.

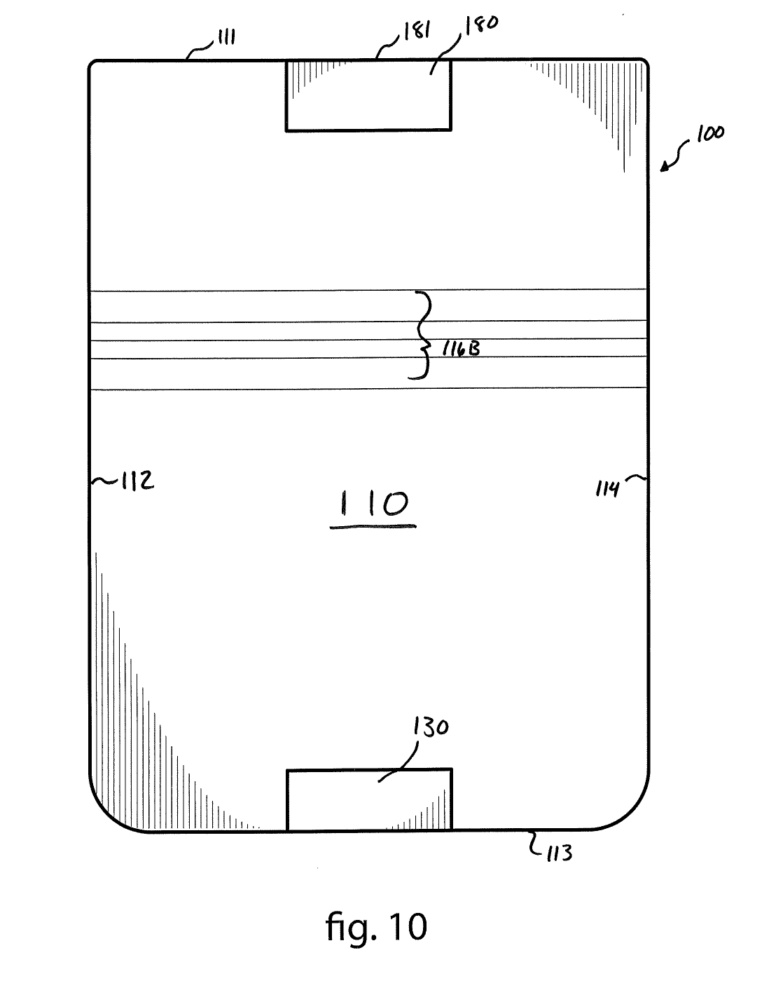

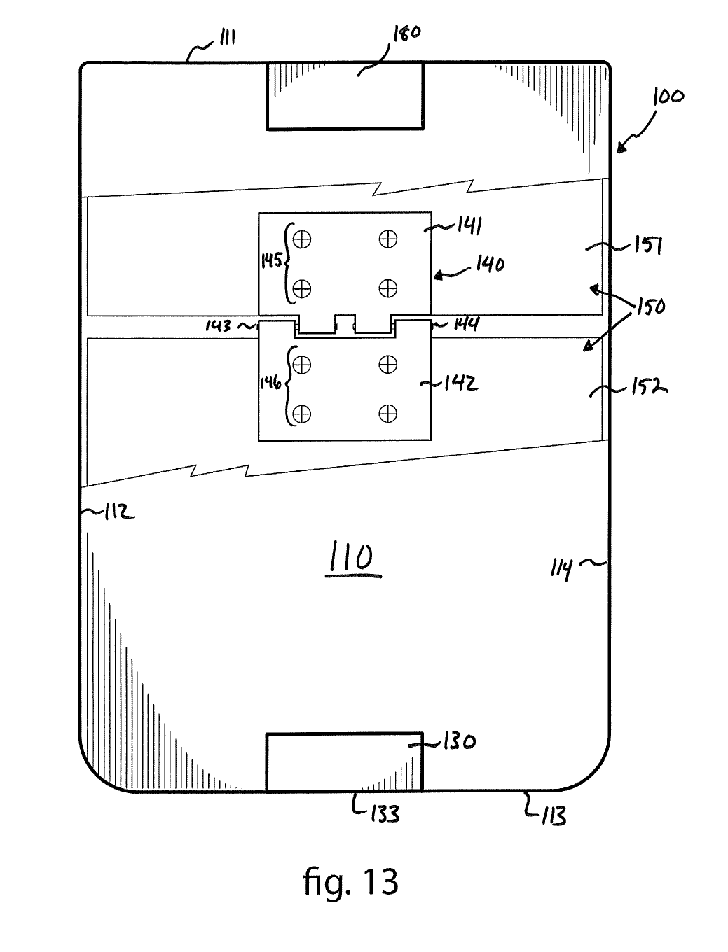

FIGS. 9-13 illustrate the mobile device popup sleeve 100 when in an unfolded position. FIG. 9 illustrates a rear perspective view of the mobile device popup sleeve 100 when in the unfolded position. FIGS. 10-12 respectively illustrate a top plan view, a bottom plan view, and a right side elevational view of the mobile device popup sleeve 100 when in the unfolded position. FIG. 13 illustrates a top plan view of the mobile device popup sleeve 100 of FIG. 1 including a cutaway view showing an internal friction hinge 140.

Referring now to FIG. 13, the internal friction hinge 140 comprises a first half 141 connected to a second half 142 by pins 143 and 144. The pins 143 and 144 are friction fit in each of the first and second halves 141 and 142 so that the hinge 140 resists folding, i.e., pivoting of the first half 141 relative to the second half 142.

As seen in FIG. 13, the mobile device popup sleeve 100 further comprises an internal support 150 comprising a first internal plate 151 and a second internal plate 152. The first half 141 of the internal friction hinge 140 is connected to the first internal plate 151 by way of a plurality of connectors 145. The second half 142 of the internal friction hinge 140 is connected to the second internal plate 152 by way of a plurality of connectors 146. The first and second internal plates 151 and 152 are rigid or semi-rigid plates and are generally planar in shape. The first and second internal plates 151 and 152 are disposed inside the mobile device popup sleeve 100 between the top surface 110 and the bottom surface 120.

In one exemplary embodiment, the connectors 145 and 146 are screws. In another exemplary embodiment, the connectors 145 and 146 are rivets. In yet another exemplary embodiment, the connectors 145 and 146 are omitted and the first and second halves 141 and 142 are secured to the first and second internal plates 151 and 152, respectively, by adhesive.

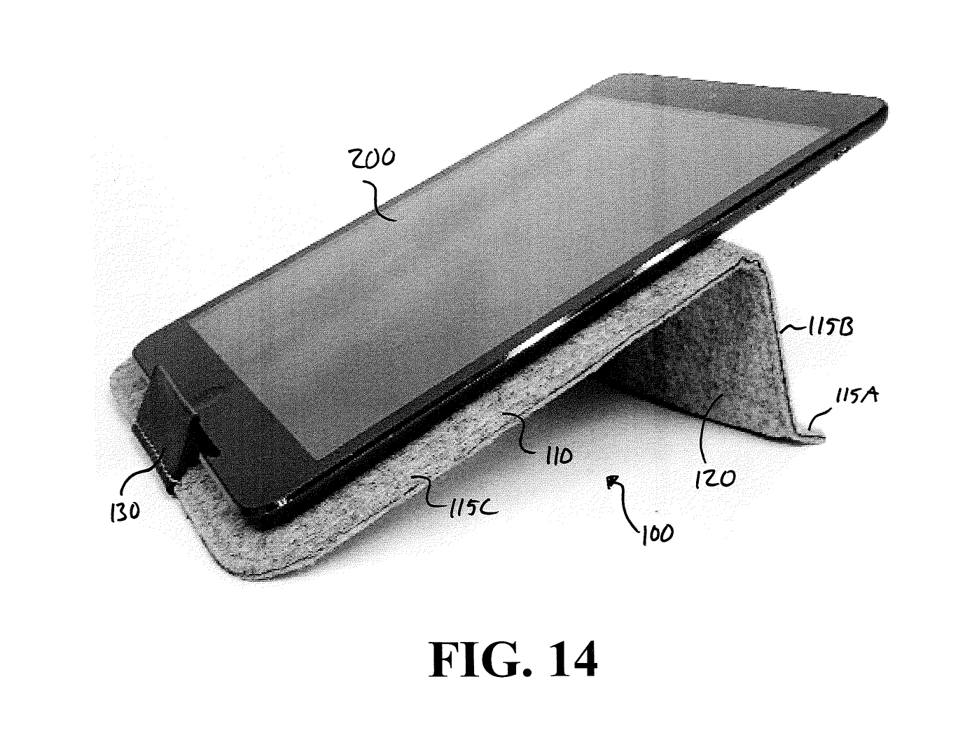

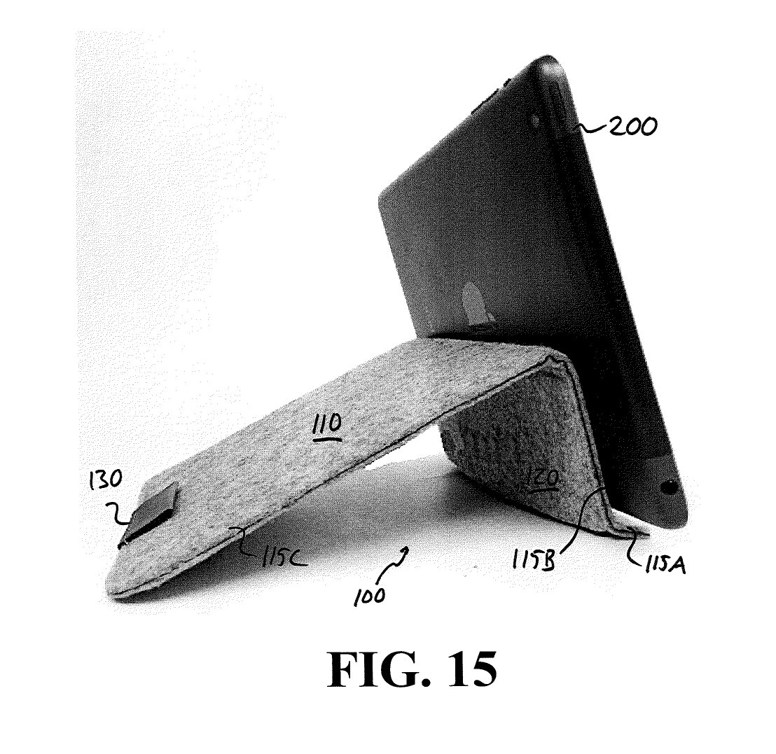

Referring now to FIGS. 14 and 15, there are illustrated two front perspective views of the mobile device popup sleeve 100 onto which the tablet computer 200 has been placed, in accordance with an exemplary embodiment of the present invention. The mobile device popup sleeve 100 thusly acts as a platform or stand for the tablet computer 200.

In FIG. 14, the tablet computer 200 is disposed on the surface portion 115C of the mobile device popup sleeve 100, and a lower edge of the tablet computer 200 rests on the surface portion 115D and under the tab 130. When in the folded position, the surface portion 115C of the mobile device popup sleeve 100 is inclined, thereby providing for a better viewing angle for a user of the tablet computer 200 resting upon the surface portion 115C. The tab 130 holds tablet computer 200 on the mobile device popup sleeve 100 when in the folded position and prevents the tablet computer 200 from sliding off the mobile device popup sleeve 100.

In FIG. 15, the tablet computer 200 is disposed on the surface portion 115B of the mobile device popup sleeve 100, and a lower edge of the tablet computer 200 rests on the surface portion 115A and under the tab 180. When in the folded position, the surface portion 115B of the mobile device popup sleeve 100 is inclined, thereby providing for a better viewing angle for a user of the tablet computer 200 resting upon the surface portion 115B. The tab 180 holds tablet computer 200 on the mobile device popup sleeve 100 when in the folded position and prevents the tablet computer from sliding off the mobile device popup sleeve 100.

With reference to FIGS. 13-15, the friction hinge 140 provides for pivoting the first internal plate 151 relative to the second internal plate 152 and maintaining their respective positions. The friction fit between the pins 143 and 144 and the first and second halves 141 and 142 of the friction hinge 140 is such that the friction hinge 140 maintains its position when a mobile computing device, such as the tablet computer 200, is disposed on to top surface 110 of the mobile device popup sleeve 100. The plates 151 and 152 provide internal support to the mobile device popup sleeve 100 and support the tablet computer 200 when resting on the top surface 110.

When the mobile computing device is stowed within the internal pocket 160 of the mobile device popup sleeve 100, the user of the mobile device popup sleeve 100 may open the pocket 160 and remove the mobile computing device. To use the mobile device popup sleeve 100 as a stand, the user pivots the plates 151 and 152 relative to one another in a closing direction, thereby pivoting the halves 141 and 142 of the hinge 140 to close the hinge 140 (such that the halves 141 and 142 are approximately at 90° relative to one another), to provide the folded position of the mobile device popup sleeve 100 seen in FIGS. 14 and 15 (and also illustrated in FIGS. 1-8). The mobile device popup sleeve 100 thereby takes on the skewed “A” shape (folded position) that provides a support stand for the table computer 200.

The mobile device mobile device popup sleeve 100 takes on the unfolded position when the user of the mobile device popup sleeve 100 pivots the plates 151 and 152 relative to one another in an opening direction, thereby pivoting the halves 141 and 142 of the hinge 140 to open the hinge 140 (such that the halves 141 and 142 are approximately in the same plane), to provide the unfolded position of the mobile device popup sleeve 100 seen in FIG. 9. The user may then access the pocket 160 to store the mobile computing device therein. FIG. 9 illustrates the pocket 160 opened, although the mobile device is omitted from FIG. 9 to provide a clear view of the pocket 160.

These and other advantages of the present invention will be apparent to those skilled in the art from the foregoing specification. Accordingly, it is to be recognized by those skilled in the art that changes or modifications may be made to the above-described embodiments without departing from the broad inventive concepts of the invention. It is to be understood that this invention is not limited to the particular embodiments described herein, but is intended to include all changes and modifications that are within the scope and spirit of the invention.

What is claimed is:

1. A sleeve for a mobile computing device, the sleeve comprising:
a top surface comprising a plurality of first edges;
a bottom surface comprising a plurality of second edges, one or more of the plurality of second edges attached to one or more of the plurality of first edges to form a pocket for the mobile computing device; and
a friction hinge disposed between the top surface and the bottom surface, the friction hinge configured to maintain its position when a mobile computing device is placed on the top surface.

2. The sleeve of claim 1, further comprising a tab attached to one of the plurality of first edges of the top surface.

3. The sleeve of claim 2, wherein the tab comprises an edge connected to the one of the plurality of first edges of the top surface.

4. The sleeve of claim 2, wherein the tab retains the mobile computing device on the inclined surface.

5. The sleeve of claim 1, further comprising a first plate disposed between the top surface and the bottom surface and a second plate disposed between the top surface and the bottom surface,
wherein the friction hinge pivotally connects the first plate to the second plate.

6. The sleeve of claim 5, wherein first and second plates are rigid.

7. The sleeve of claim 1, wherein the sleeve is flat and in an unfolded position when the mobile computing device is disposed within the pocket.

8. A sleeve for a mobile computing device, the sleeve comprising:
a top surface comprising a plurality of first edges;
a bottom surface comprising a plurality of second edges, one or more of the plurality of second edges attached to one or more of the plurality of first edges for form a pocket for the mobile computing device, the pocket comprising an opening; and
a friction hinge disposed between the top surface and the bottom surface, the friction hinge configured to maintain its position when a mobile computing device is placed on the top surface,
wherein the friction hinge is configured to incline a portion of the top surface when in a closed position to provide an inclined surface onto which the mobile computing device may be disposed.

9. The sleeve of claim 8, further comprising a tab attached to one of the plurality of first edges of the top surface.

10. The sleeve of claim 9, wherein the tab comprises an edge connected to the one of the plurality of first edges of the top surface.

11. The sleeve of claim 9, wherein the tab retains the mobile computing device on the inclined surface.

12. The sleeve of claim 8, further comprising a first plate disposed between the top surface and the bottom surface and a second plate disposed between the top surface and the bottom surface,
wherein the friction hinge pivotally connects the first plate to the second plate.

13. The sleeve of claim 12, wherein first and second plates are rigid.

14. The sleeve of claim 8, wherein the sleeve is flat and in an unfolded position when the mobile computing device is disposed within the pocket.
